(19) United States
(12) Patent Application Publication
(10) Pub. No.: US 2021/0048781 A1
(43) Pub. Date: Feb. 18, 2021

(54) ORGAN FOR ELASTICALLY HOLDING A TIMEPIECE COMPONENT ON A SUPPORT ELEMENT

(71) Applicant: Nivarox-FAR S.A., Le Locle (CH)

(72) Inventors: Romain LE MOAL, Villers-le-Lac (FR); Frederic VAUCHER, La Chaux-de-Fonds (CH); Pierre CUSIN, Villars-Burquin (CH)

(73) Assignee: Nivarox-FAR S.A., Le Locle (CH)

(21) Appl. No.: 16/904,655

(22) Filed: Jun. 18, 2020

(30) Foreign Application Priority Data
Aug. 16, 2019 (EP) 19192159.2

(51) Int. Cl. G04B 17/32

(52) U.S. Cl. CPC G04B 17/32

(57) ABSTRACT

An elastic holding organ for fastening a timepiece component on a support element, including a rigid portion provided with an inner face including at least three deformable arms provided with free ends defining an opening into which the support element can be inserted, the arms being configured to perform a coupling with the support element by an elastic clamping in compression of this support element in the opening.

### TECHNICAL FIELD

The invention relates to an organ for elastically holding a timepiece component on a support element.

The invention also relates to an elastic holding organ-timepiece component set and an assembly comprising such a set and this support element.

The invention finally relates to a horological movement comprising this assembly as well as to a timepiece comprising such a movement.

### TECHNOLOGICAL BACKGROUND

In the state of the art, elastic holding organs are known, such as clockwork collets, generally made of materials called fragile materials such as silicon which contribute in assembling balance-springs on shafts of regulating organ balance such as horological movement resonators, by a coupling of the elastic clamping type made from a coupling system comprising deformable arms such as elastic blades which are conventionally stressed in bending.

However, one of the major disadvantages of these holding organs is related to the fact that the coupling system that they implement allows obtaining only a small elastic clamping force in the given dimensions because the breakage limit stress of the material constituting these holding organs is often reached quickly.

The purpose of the invention is to provide an alternative to the existing holding organs.

### SUMMARY OF THE INVENTION

In this purpose, the invention relates to an elastic holding organ for fastening a timepiece component on a support element, including a rigid portion comprising an inner face comprising at least three deformable arms provided with free ends defining an opening into which said support element can be inserted, the arms being configured to perform a coupling with the support element by an elastic clamping in compression of this support element in the opening.

Thus, such features contribute in obtaining a holding organ capable of performing a coupling by elastic clamping in compression which is high, without exceeding the breakage limit stress of the material constituting this holding organ.

In other embodiments:
each deformable arm consists essentially of a main part including a material volume which regularly decreases from a direction from this inner face towards a central axis of said organ;
rigid portion comprises a material volume which is greater than the sum of the material volumes of the deformable arms 4 of this holding organ;
each arm has an essentially trapezoidal shape;
the inner face defines a volume in said organ partially occupied by the deformable arms;
the organ comprises six deformable arms;
the organ is made of a fragile material, in particular a micromachinable material;
the organ is a collet;

The invention also relates to an elastic holding organ-timepiece component set for a horological movement of a timepiece comprising such a holding organ.

The invention also relates to an assembly for a horological movement of a timepiece comprising an elastic holding organ-timepiece component set and a support element, said set being coupled by an elastic clamping in compression with the support element.

The invention also relates to a horological movement comprising at least one such assembly.

The invention also relates to a timepiece comprising such a horological movement.

### BRIEF DESCRIPTION OF THE FIGURES

The invention will be described below in more detail using the appended drawings, given by way of non-limiting examples, wherein:

FIG. 1 shows a sectional view of a first variant of the holding organ in a rest configuration, according to an embodiment of the invention;

FIG. 2 shows a sectional view of the first variant of the holding organ in a stress configuration, mounted on a support element, according to the embodiment of the invention;

FIG. 3 shows a sectional view of a second variant of the holding organ in a rest configuration, according to the embodiment of the invention;

FIG. 4 shows a sectional view of a third variant of the holding organ in a rest configuration, according to the embodiment of the invention, and

FIG. 5 is a schematic view of a timepiece comprising the assembly including the elastic holding organ-timepiece component set coupled to the support element, according to the embodiment of the invention.

### DETAILED DESCRIPTION OF THE INVENTION

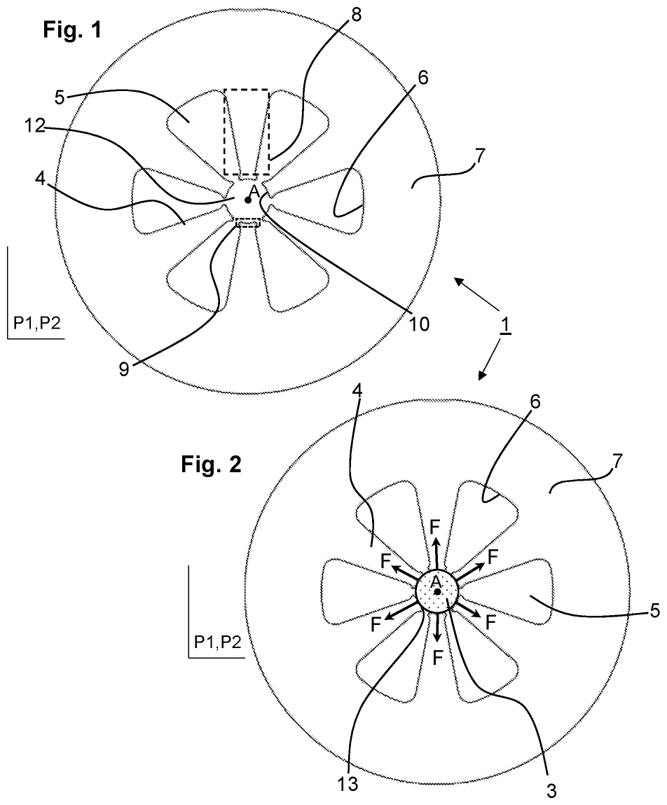

FIGS. 1 to 5 show different variants of the elastic holding organ 1a, 1b, 1c for fastening a timepiece component 2 on a support element 3. For example, the elastic holding organ 1a, 1b, 1c can be a ring or else a collet or any piece capable of ensuring the fastening of the timepiece component 2 such as a balance-spring or else a wheel, to a support element 3 such as a shaft. This elastic holding organ 1a, 1b, 1c is made of a material called “fragile” material, preferably a micromachinable material. Such a material can comprise silicon, quartz, corundum, silicon and silicon dioxide, DLC, metallic glass, ceramic, other at least partially amorphous material, or the like.

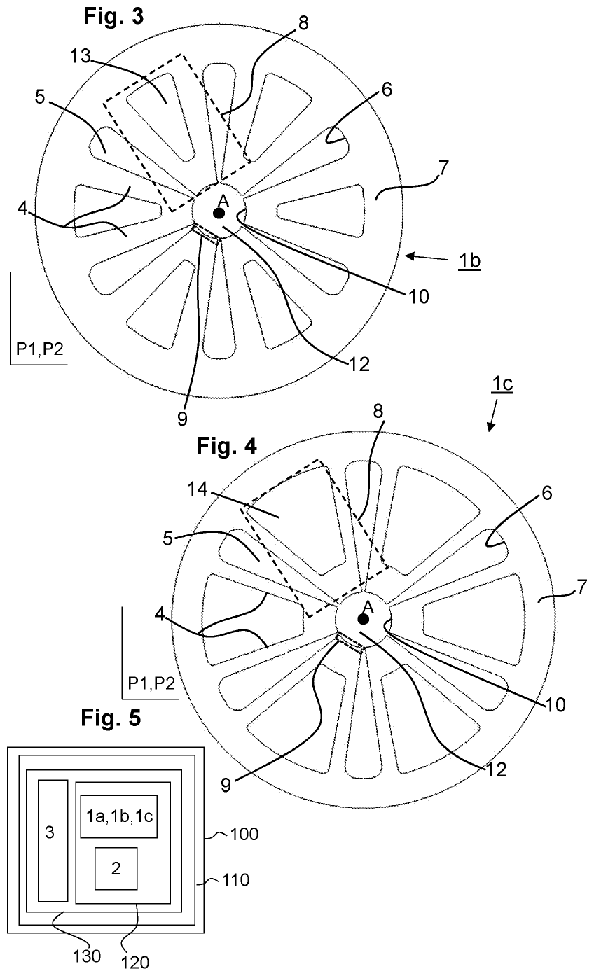

In this embodiment, this holding organ 1a, 1b, 1c can be comprised in an elastic holding organ-timepiece component set 120. Such a set 120 is provided to be arranged in a horological movement 110 of a timepiece 100 visible in FIG. 3, and also intended to be mounted on a support element 3. Such a set 120 may be made in one piece and be made of a “fragile” material similar to that of the holding organ 1. It will be noted that in a variant of this set 120, only the elastic holding organ 1a, 1 b, 1c can be made of such a material called “fragile” material, the timepiece component 2 then being made of another material.

This set 120 may be part of an assembly 130 for the horological movement 110. Here, such an assembly 130 has been conceived for applications in the watchmaking field. However, this assembly 130 can perfectly be implemented in other fields such as aeronautics, jewellery, or else the automobile.

Such a holding organ 1a, 1b, 1c is preferably made in one piece which comprises a preferably planar upper face and lower face, which are both comprised respectively in first and second planes P1 and P2. This organ 1a, 1b, 1c also has a thickness which extends from the upper face to the lower face. Such a holding organ 1a, 1b, 1c also comprises a rigid portion 7 provided with an inner face 6. This rigid portion 7 corresponds to the part of the holding organ 1a, 1b, 1c which comprises the most significant material volume/amount. In other words, the rigid portion 7 comprises a material volume/amount which is greater than the material volume/amount of the set of deformable arms 4 of the holding organ 1a, 1b, 1c. It is therefore understood that the rigid portion 7 includes a material volume which is greater than the sum of the material volumes of the deformable arms 4 of this holding organ 1a, 1b, 1c. The holding organ 1a, 1b, 1c may also comprise an outer face or outer peripheral wall, in particular when it is a collet which is in particular intended to be connected to the timepiece component 2 via at least one attachment point arranged in this outer face. In a variant, such an outer face, and therefore the holding organ 1, may be made integrally with the timepiece component 2 when the latter is a wheel visible in FIGS. 1 and 2.

In this holding organ 1a, 1b, 1c, the inner face 6 contributes in defining a volume 5 wherein at least three deformable arms 4 provided with free ends 9 are arranged. In the present embodiment, this organ 1a, 1b, 1c comprises six arms 4 shown in FIGS. 1 and 2. It will be noted that this volume 5 is only partially occupied by these deformable arms 4. Such arms 4 are comprised in the inner face 6 and extend radially from this face 6 to a central axis A of said holding organ 1a, 1b, 1c. In the first variant illustrated in FIGS. 1 and 2, these deformable arms 4 essentially consist of a main full/non-openworked part 8, including a material volume/amount which decreases regularly in a direction extending from this inner face 6 to the central axis A. In the second and third variants visible in FIGS. 3 and 4, the deformable arms 4 essentially consist of a main openworked part 8, with a greater openwork 14 in the third variant than that 13 of the second variant. In these second and third variants, the material volume/amount also decreases regularly in a direction extending from this inner face 6 to the central axis A. In addition, it is therefore understood that the material volume/amount in the main part 8 of each arm 4 of the third variant is less than in that of each arm 4 of the second and even less than in that of each arm 4 of the first variant.

It will be noted that each of these arms 4 preferably has an essentially trapezoidal or else “V” shape. In other words, each arm 4 has a flared shape extending from the free end 9 to the inner face 6.

These deformable arms 4 each comprise two ends, a first end connected to the inner face 6 of the holding organ 1a, 1b, 1c and a second end which is the free end 9 visible in FIG. 1. This free end 9 comprises a contact face 10 having a shape configured/adapted to cooperate with a mounting area of the support element 3 intended to cooperate with this contact face 10. By way of example in these variants, when this mounting area is defined on a cylindrical shaped part of the support element 3 then the contact face 10 has a compatible shape capable of matching this cylindrical shape by being for example a curved contact face 10. The free ends 9 of these arms 4 together define an opening 12 into which said support element 3 can be inserted. This opening 12 defines a volume in the holding organ 1a, 1b, 1c which is lower than that of the mounting area comprised in one end of the support element 3 which is provided to be arranged therein.

In this context, the mounting area of the support element 3 comprises all or part of the contact portions 13 of this support element 3 with the holding organ 1a, 1b, 1c which are defined on a peripheral wall of this support element 3 and which are provided in particular to cooperate with the arms 4 of this holding organ 1a, 1b, 1c. It will be noted that this support element 3 comprises at least as many portions 10 as the holding organ 1a, 1 b, 1c comprises arms 4.

In this holding organ 1, each arm 4 is capable of being deformed in compression, that is to say radially relative to the central axis A of the holding organ which is coincident with that of the axis of the opening 5. In other words, each of these arms 4 when it is subjected to a stress induced by the support element 3 as will be seen later, is capable of being deformed when switching from a rest configuration to a stressed configuration. In this context, when switching from this rest configuration to the stressed configuration, all or part of this arm 4 is then radially compressed relative to the central axis A to the inner face 6 of the holding organ 1. Such arms 4 exert a force against the support element, thus allowing to ensure an elastic clamping coupling of the support element 3 in the opening 12 while being configured to be radially compressed/deformed relative to the central axis A of said opening 5.

It will be noted that the disposition of the deformable arms 4 in the holding organ 1a, 1 b, 1c allows, during insertion with clamping, a deformation of each arm 4 allowing to accommodate the deformation of the holding organ 1a, 1b, 1c with the geometry of the mounting area of the support element 3.

Thus, during the mounting of this holding organ 1a, 1b, 1c on the support element 3, one end of this support element 3 comprising the mounting area is then inserted into the opening 12 defined in the holding organ 1. In this context, this mounting area which comprises the contact portions 13 of this support element 3, is preferably arranged coaxially with the opening 12, around the central axis A which is common to this mounting area and to this opening 12 of the holding organ 1. Such an arrangement around this common axis A contributes in indexing this mounting area relative to the opening 12 during this insertion. More specifically, during this insertion, the contact faces 10 undergo a radial deformation therefore the arms 4 then undergo an elastic deformation under the effect of the application on the contact faces 10 of the arms 4 by the contact portions 13 of the mounting area of the support element 3, of a compressive force F illustrated in FIG. 2. Such a compressive force F generates an elastic deformation in compression of each arm 4 in a radial direction relative to the central axis A, to the first end of the arm 4 connected to the inner face 6 of the holding organ 1a, 1b, 1c. Such a deformation contributes in particular in that the holding organ 1a, 1b, 1c stores a large amount of elastic energy which contributes to giving it a substantial holding torque, in particular allowing optimum holding by elastic clamping in compression. In addition, it will be noted that such an elastic organ 1a, 1 b, 1c allows considerably increasing the clamping force in comparison with the elastic organs of the state of the art, indeed this clamping force is here approximately twice as large as that of the organs of the state of the art for the same configuration.

1. An elastic holding organ for fastening a timepiece component on a support element, including a rigid portion comprising an inner face comprising at least three deformable arms provided with free ends defining an opening into which said support element can be inserted, the arms being configured to perform a coupling with the support element by an elastic clamping in compression of said support element in the opening.

2. The organ according to claim 1, wherein each deformable arm consists essentially of a main part comprising a material volume which regularly decreases from a direction from said inner face towards a central axis of said organ.

3. The organ according to claim 1, wherein the rigid portion comprises a material volume which is greater than the sum of the material volumes of the deformable arms 4 of said holding organ.

4. The organ according to claim 1, wherein each arm has an essentially trapezoidal shape.

5. The organ according to claim 1, characterised in wherein the inner face defines a volume in said organ partially occupied by the deformable arms.

6. The organ according to claim 1, comprising six deformable arms.

7. The organ according to claim 1, wherein it is made of a fragile material, in particular a micromachinable material.

8. The organ according to claim 1, wherein it is a collet.

9. An elastic holding organ-timepiece component set for a horological movement of a timepiece comprising a holding organ according to claim 1.

10. An assembly for a horological movement of a timepiece comprising an elastic holding organ-timepiece component set according to claim 9, and a support element, said set being coupled by an elastic clamping in compression with the support element.

11. A horological movement comprising at least one assembly according to claim 10.

12. A timepiece comprising a horological movement according to claim 11.
